(19) United States
(12) Patent Application Publication
(10) Pub. No.: US 2020/0175603 A1
(43) Pub. Date: Jun. 4, 2020

(54) Method for structuring a finance agreement efficiently to include an insurance component appendix to hedge against risk from unforeseeable events and defaults through a contractual risk transfer atructure

(71) Applicant: Liberty Capital Management (Cyprus Limited), Limassol (CY)

(72) Inventors: P. Mario DiNello, Fraser, MI (US); Robin Pointer, Fraser, MI (US)

(21) Appl. No.: 15/999,669

(22) PCT Filed: Sep. 3, 2017
(86) PCT No.: PCT/US2017/021576

§ 371 Date: Aug. 20, 2018

(51) Int. Cl. G06Q 40/08; G06Q 10/10; G06Q 40/02

(52) U.S. Cl. CPC G06Q 40/08; G06Q 40/025; G06Q 10/103

(57) ABSTRACT

Method for providing financial asset protection for a project, by creating a Risk Transfer Structure to protect the assets, revenue stream(s), including but not limited to protection of Lender(s) interest and principal payment obligations, and liabilities of the Business/Borrower by providing a strategy that contractually hedges risk at all levels of a funded project, thereby limiting potential exposures to the Borrower and Lender, without negatively impacting the overall financial condition of the Business or its ability to meet its financial obligations. An insurance policy provides, by contract, language and a template that allows the primary insurer and reinsurer to act as the Lender for specific projects and pays financial asset Lender(s) for their loan amount through an all risk policy. This reduces the need for the servicer to engage in additional investing in order to hedge against default risks during the life of the loan.

### Provisional Appl. No.: 62/307,075

Filed USA:

Mar. 11, 2016

### REFERENCES CITED cl U.S. Patent Documents

| | | |
|---|---|---|
| 8,589,299 | November 2013 | Baker et al. |
| 8,566,127 | October 2013 | Strech |
| 9,153,076 | October 2015 | Snyder |
| 8,930,241 | January 2015 | Grigg |
| 8,799,129 | August 2014 | Goodart et al. |
| 8,799,051 | August 2014 | Brown |

### Other References

Attorney, Agent or Firm: Submitted by the Inventors

### BACKGROUND AND DESCRIPTION OF INVENTION

Background. Typically a loss payable provision in an insurance policy specifies that the insurance will authorized payment in the event of loss to a person or entity other than the named insured with an insurable interest in the covered property or, in some cases, jointly to the insured and the other person or entity. Under a typical loss payable clause, the insurer is under no obligation to make payment to the loss payee if payment for a loss can be denied to the insured. If the insurer makes any payments to the loss payee, the insurer obtains the loss payee's (subrogation) rights against any other party. Loss payable clauses are common in commercial auto and personal auto policies in which one or more vehicles are financed through a financial services company.

The coverage afforded to the loss payee under the aforementioned typical provision is “as its interest may appear.” in other words, it will only pay the financial institution's actual loss sustained, even if the value of the vehicle, or asset is greater. Loss payable clauses are also commonly used in commercial property insurance policies to protect the interest of an entity that has extended credit or leased personal property to the insured and typically included in the insurance policy as “additionally insured”.

Lender as a creditor who has loaned money in connection with the insured's property or project, with the same rights and duties that a mortgage clause gives a mortgagee, for example, Section (9) of the Fannie Mae/Freddie Mac Uniform Instrument for single-family residential mortgage loans in Ohio provides:

“Protection of Lender's Interest in the Property and Rights Under this Security Instrument. If (a) Borrower fails to perform the covenants and agreements contained in this Security instrument, (b) there is a legal proceeding that might significantly affect Lender's interest in the Property and/or rights under this Security Instrument (such as a proceeding in bankruptcy, probate, for condemnation or forfeiture, for enforcement of a lien which may attain priority over this Security instrument or to enforce laws or regulations), or (c) Borrower has abandoned the Property, then Lender may do and pay for whatever is reasonable or appropriate to protect Lender's interest in the Property and rights under this Security Instrument, including protecting and/or assessing the value of the Property, and securing and/or repairing the Property Securing the Property includes, but is not limited to, entering the Property to make repairs, change locks, replace or hoard up doors and windows, drain water from pipes, eliminate building or other code violations or dangerous conditions, and have utilities turned on or off. Although Lender may take action under this Section 9, Lender does not have to do so and is not under any duty or obligation to do so. It is agreed that Lender incurs no liability for not taking any or all actions authorized under this Section 9. (emphasis added)

Description. The business method patent disclosed herein describes a procedure whereby the Lender can also be the insurer, and can thus be enabled by the coverage defined within the policy and appendixes to invoke the Insurer's provision to ensure payment “as its interest may appear” to cover losses by the Lender as a creditor who has loaned money in connection with the insured's property or project, with the same rights and duties that a mortgage clause as described herein, gives to a mortgagee with a proviso of including an addendum of obtaining and maintaining reinsurance to protect the interests of the lender/primary insurance company. The policy will provide coverage for use of contractual obligations such as indemnity and exculpatory agreements, convertible debenture, waivers of recovery rights, insurance premiums, and insurance requirements to pass along to others what would otherwise be at the lender's one's own risks of loss.

In property insurance, additional insured status is most often used in conjunction with a premises lease agreement between the named insured as the lessee and the owner of the leased building, in which the insured tenant is required to purchase insurance on the leased building and name the building owner as an additional insured on the insurance policy with respect to the leased building. It is also typically a requirement for a General Contractor when enlisting the services of a sub-contractor for any type of municipal or construction project.

The method disclosed herein is a novel form of financing of a project because it provides an all risk insurance policy that also covers the interests of an insurance company/lender, including insurance coverage that is similar to that of an ‘additionally insured’ individual or organization however, this proviso for insuring the financial risks of an insurer/lender, did not formerly include certain parties, such as the primary insurance company/lender. This provision by contract and in the appendixes, usually Appendix A, as part of the policy wherein the language within the policy shall also include indemnification of the Lender under the indemnitor's commercial general liability policy, having the rights of an insured under its indemnitor's commercial general liability (CGL) policy as a way of backing up the promise of indemnification. If the indemnity agreement proves unenforceable for some reason, the indemnitee may still be able to obtain coverage for its liability by making a claim directly as an additional insured under the indemnitor's CGL policy.

### DISCRIPTION OF FIGURES

FIG. 1 describes a flow chart of the method described herein including Identity of Risks, Risk Analysis, Avoidance, Mitigation, Risk Mitigation, Transfer of Risk including Contractual Obligations and Insurance, Acceptance, Risk Financing, and Total Cost of Risk.

The invention claimed is:

1. A method implemented whereby an insurance policy is issued as an all risk policy wherein language is set fourth that insures a financial asset relative to a qualifying project (hereinafter “PROJECT”) requiring a loan whether directly issued by and individual or business, or government agency, or wholesaler so as to structure and enhance a financial asset to include a hedging component thereby creating a risk transfer structure comprising the steps of:
providing a structure for projects that are not rated and are insured by a primary insurance company who insures the financial asset by way of an all-risk policy, thereby acting as co-signer; and
a licensed insurance company will bring in an A or better rated; and
an underwriter or reinsurer provides the insurance for the loan amount based on the A or better credit rating; and
underwriter or reinsurer can syndicate the financial asset to anyone they wish within their business acumen; and
a primary insurance company writes the policy with the equivalency of a bank guarantee.

2. A method as cited in claim I whereby the primary and underwriter insurance provides coverage for any PROJECT overview construction and operational costs including:
i. full hot testing,
ii. commissioning,
iii. acceptable activities during constructions,
iv. cost over-runs
v. changes in regulations
vi. delays due to adverse weather
vii. health problems, death of key individuals, or separation from the PROJECT by key individuals
viii. also business interruption coverage including interest and principle payment obligations;

3. A method as cited in claim 1 whereby a lender's obligations are separately protected whether the business is in a profitable position or not; and will insure the financial obligations of the PROJECT for credit risk, coverage including bankruptcy or insolvency on the part of the insured or any primary source of funds to the PROJECT, or any third parties to whom a financial obligation is due from the PROJECT.

4. A method as cited in claim 1 whereby a primary insurance company will include as part of the policy a specific section that is developed where the reinsurer is included as a loss payee for interest and obligations; and provides a novel form of financing of a project because it provides an all risk insurance policy that also covers the interests of an insurance company/lender, including insurance coverage that would typically be The method disclosed herein is a novel form of financing of a project because it provides an all risk insurance policy that also covers the interests of an insurance company/lender including insurance coverage that is similar to that of an ‘additionally insured’ individual or organization however, this proviso for insuring the financial risks of an insurer/lender, did not formerly include certain parties, such as the primary insurance company/lender.

5. A method as cited in claim 1 whereby, in the instance of a qualifying claim, the insurance company will pay for loss specified property insured under this policy to each specified lender, loss payee, (hereinafter referred to as lender) as its interest may appear, all present and future loans, leases, or mortgages upon such property in order of precedent, including all insurance premiums due by contract.

6. A method as cited in claim 1 whereby, under this plan none of the interest of the lender nor any of the property insured under this financial asset shall not be invalidated by:
i. any act or neglect of the debtor or owner (as the case may be of the property),
ii. foreclosure, notice to sale, or similar proceedings with respect to the property,
iii. change in the title or ownership of the property,
iv. change to a more hazardous occupancy
v. Political Risk, altering of power sales or other contract, confiscation, and various other events

7. A method as cited in claim 1 whereby an insurance policy shall include an index of coverage that shall list the following:
i. there are different listed coverages in what is typically labeled: Sections 1 of a policy (by example as Section 1), or whichever “Section” is identified by number that's context includes the list of “General Conditions”, which will typically include direct damage, etc.;
ii. in this embodiment of the invention the information representations listed. typically as Section 8 (hereinafter by example as Section 8), or whichever “Section” is identified by number that's context dictates the terms of the loss payee's interest and obligations clause which by example is hereinafter referred hereinafter as “Appendix A”, which referrers to the “Loss Payable Clause” that is included as part of the policy;

8. A method as cited in claim 1 whereby this embodiment cited in claim 7 includes the provision:
i. “loss hereunder if any is payable to insured as they may direct, may be payable to insured or as they may direct, and to any loss payees or mortgagee as shown in Appendix A” (or any Appendix identified by number or letter or symbol wherein the aforementioned language described in claim 8 (i) is include is referred to hereinafter as Appendix A)
ii. furthermore, Appendix A shall state the autonomy of the insurance company and the lender as part of the policy: Example: “National Standard may direct the loss to whomever they direct”;
iii. all rights of the lender are listed in Appendix A allowing the lender in effect to -rite their own policy

9. A method as cited in claim 1 whereby the language of a policy will include the provisions specifying that “whenever the insured has entered into a mortgage and/or loan lease or lean agreement, the interest of the lender or lean holder is hereby protected subject to the terms and conditions of the lenders loss payee interest and obligations clause attached thereto” ; and “if the lender or mortgagee, utilizes their own special mortgage clause, it is understood and agreed that the terms and conditions of this clause is incorporated therein respect to their interest and subject to the lenders loss payee interest and obligations clause contained herein as their interests may appear.”

10. A method as cited in claim 1 whereby the language of a policy will include specific language to be included as part of Appendix A and will include the provision of a Lease Reserve Account Agreement:
i. the Lease Reserve Account Agreement is written by the lender's attorney, so it may be different from different lenders who will put all of the protection for the debt that the lender wants to be incorporated into appendix A as part of the policy.

11. A method as cited in claim 1 whereby the language of a policy will include specific language to be included as part of Appendix A and will include the parameters that are unique in that all of the participants and aspects of the financial instrument and transaction are protected within the language specification detailed in and as part of the policy and Appendixes, and that the specific language detailed within the parameters are applicable to any insurer of a financial right or instrument involving a Borrower, a Lender as the Primary Insurer, a Reinsurer or Underwriter, and a Trustee of the Lease Reserve Account, and a Trustee of an Escrow and Deposit Account Control Agreement, with the proviso that the Appendix A, shall contain the risk protection for operations, performance, and obligations as part of an insurance policy.

12. A method as cited in claim 1 whereby the language of a policy will include specific language to be included as part of Appendix A and will include specifications that if the Primary Insurance policy provides insurance for a PROJECT, the principle and interest is protected.

13. A method as cited in claim 1 whereby the language of a policy will include specific language to be included as part of Appendix A and will include the provision insured PROJECT provide an Escrow and Deposit Account Control Agreement wherein very detailed language between the Borrower, the Lender, are clearly described along with the mechanism and terms by which the insurance company will pay for any of the Covered Events detailed as specified in Example, Section 8.

14. A method as cited in claim 1 whereby the language of a policy will include specific language to clearly state that the insurance policy is an All Risk Policy, issued to the Lender by the A rated insurance company and the mechanism utilized is the Lease Reserve Account, which provides security for the enactment of the procedure, and takes any contestability out of the hands of insurance company;
i. Example: the Lender shall include the language and specifications of Appendix A and Section 8 to the policy to make certain that all payments are made without contest.

15. A method as cited in claim 1 whereby the language of a policy will include specific language to be included as part of Appendix A and will include provisions describes a procedure whereby a Lender is also the insurer and thus enabled by the coverage defined within the policy and appendixes to invoke the Insurer's provision to ensure payment “as its interest may appear” to cover losses by a Lender as a creditor who has loaned money in connection with the insured's property or project, with the same rights and duties that a mortgage clause gives a mortgagee with the addendum of having reinsurance to protect the interests of the lender/primary insurance company; and the policy will provide coverage for use of contractual obligations such as indemnity and exculpatory agreements, waivers of recovery rights, and insurance requirements to pass along to others what would otherwise be at the lender's one's own risks of loss.

16. A method as cited in claim 1 whereby the language of a policy will include specific language to be included as part of Appendix A and will include provisions describes a procedure whereby the Lender if also the insurer can thus be enabled by the coverage defined within the policy and appendixes to invoke the Insurer's provision to ensure payment “as its interest may appear” to cover losses by the Lender as a creditor who has loaned money in connection with the insured's property or project, with the same rights and duties that a mortgage clause gives a mortgagee with the addendum of having reinsurance to protect the interests of the lender/primary insurance company. The policy will provide coverage for use of contractual obligations such as indemnity and exculpatory agreements, waivers of recovery rights, and insurance.

17. A method as cited in claim 1 disclosed at novel form of insurance coverage that is similar to that of an ‘additionally insured’ individual or organization that previously was not included as an insured party under a previously crafted insurance policy where a party is included or added as an insured under the policy as a provision of the loan agreement, and described in the appendixes or Appendix A, as part of the policy wherein the language within the policy shall include indemnification of the Lender under the indemnitor's commercial general liability policy, having the rights of an insured under its indemnitor's commercial general liability (CGL) policy as a way of backing up the promise of indemnification.

18. A method as cited in claim 1 whereby the PROJECT shall be assessed by the lender and PROJECT manager, for submission to an insurance company for final approval and rating, and will provide a written Assessment of the risks of the Project and future operations, and develop Risk Transfer structure that will satisfy lender(s).

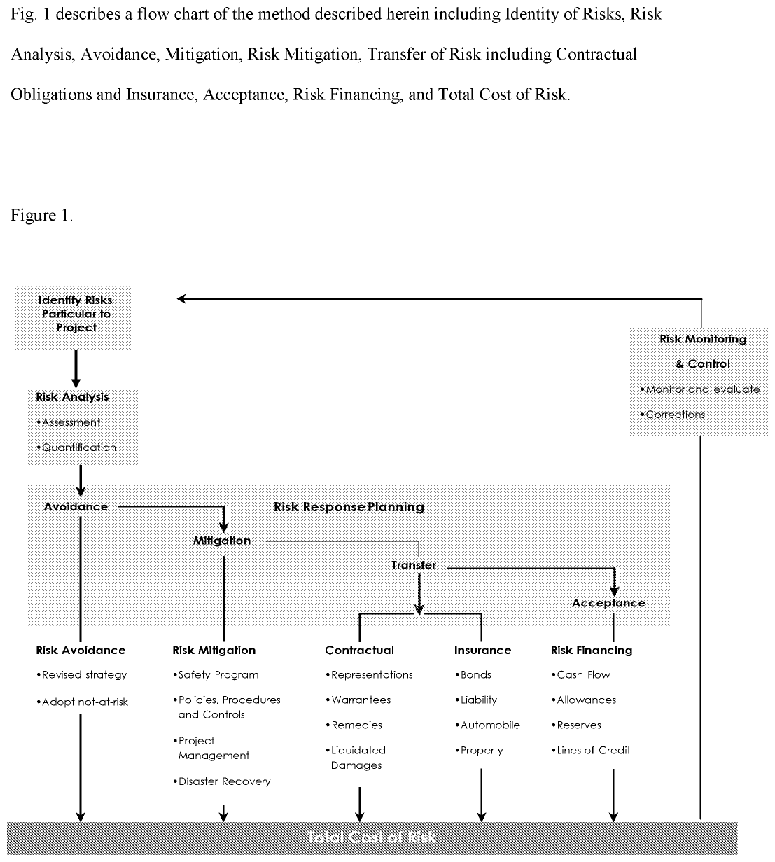

19. A method as cited in claim 1 whereby the insurer will implement, and broker the placement of the Risk Transfer program for the Project as described in FIG. 1.

20. A method as cited in claim 1 whereby the language of a policy will include provision that an insurance policy will insure the investment that is put into the project so that the liable party will fulfill the obligation for the investment to the investor, including convertible debenture financial instruments that declare an interest rate that is less than usury, but non-the-less, an obligation of the PROJECT to repay, regardless of whether or not the investor is determined to convert the debenture into shares of the company sponsoring the PROJECT.
